(19) United States
(12) Patent Application Publication
(10) Pub. No.: US 2013/0082578 A1
(43) Pub. Date: Apr. 4, 2013

(54) DYNAMOELECTRIC MACHINE HAVING AN INTEGRATED FAN

(71) Applicant: Günther Winkler, Haibach (AT)

(72) Inventor: Günther Winkler, Haibach (AT)

(73) Assignee: Siemens Aktiengesellschft, Munchen (DE)

(21) Appl. No.: 13/703,253

(22) PCT Filed: May 6, 2011
(86) PCT No.: PCT/EP2011/057268

§ 371 Date: Dec. 10, 2012

(30) Foreign Application Priority Data
Jun. 11, 2010 (DE) 10 2010 029 997.9

(51) Int. Cl. H02K 9/06

(52) U.S. Cl. CPC H02K 9/06
USPC 310/60 R

(57) ABSTRACT

A dynamo-electric machine, in particular a multi-pole dynamo-electric machine includes a shaft and an integrated fan which is connected to the shaft by a friction-wheel planetary gear. The friction-wheel planetary gear has first and second rolling bearings, with the first rolling bearing having an outer ring mounted in the hub of the fan, and the second rolling bearing having an outer ring which is press-fitted in the hub of the fan. Arranged between the first and second rolling bearings is a driving bush for transmitting a rotational speed of the shaft onto balls of the second bearing to thereby increase a rotational speed of the fan by a predefined factor compared to the rotational speed of the shaft.

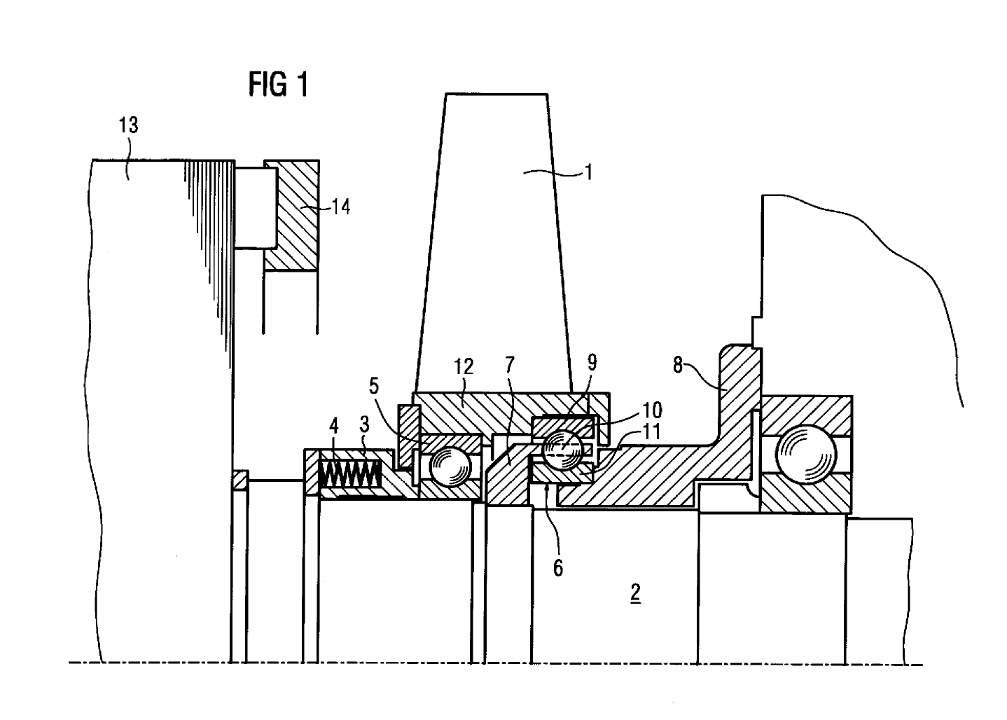

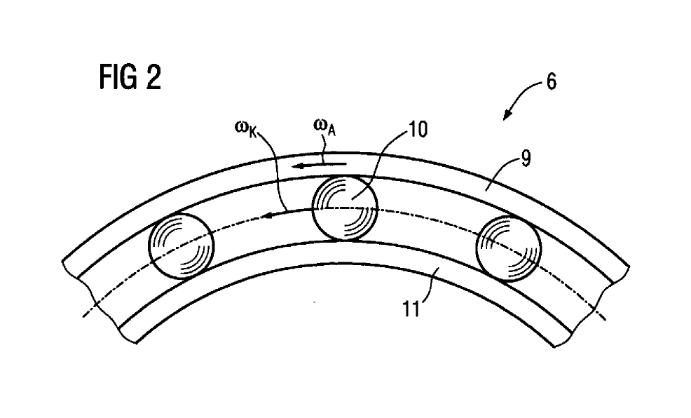

The invention relates to a dynamoelectric machine having an integrated fan on a shaft.

In dynamoelectric machines, electric motors and generators having integral ventilation the rotational speed of a rotor and of the fan integrated on a shaft and co-rotationally connected to the shaft are the determining variable for the coolant throughput. In particular with multipole dynamoelectric machines, i.e. with comparatively slowly rotating rotors, the coolant throughput caused by rotation of the fan is seldom sufficient to ensure adequate cooling of the dynamoelectric machine.

In the prior art adequate cooling is achieved in that an additional external forced ventilation of the dynamoelectric machine is provided. However, this means a higher technical complexity and higher manufacturing costs of the dynamoelectric machine.

Proceeding on this basis, the object underlying the invention is to provide a dynamoelectric machine, in particular a multipole dynamoelectric machine having an integrated fan which ensures adequate cooling of the dynamoelectric machine.

The addressed object is successfully achieved by means of a dynamoelectric machine, in particular a multipole dynamoelectric machine having a shaft and having an integrated fan which is connected to the shaft by means of a friction-wheel planetary gear.

By installing a compact friction gear in the form of a friction-wheel planetary gear at the fan hub it is possible to increase the rotational speed of the fan by a predefinable factor compared to the rotational speed of the shaft. A factor of 2 has proven suitable in practice. This also results in a multiplication of the air mass conveyed by means of the driven fan in the dynamoelectric machine.

Advantageously, this solution of the friction-wheel planetary gear is realized on the basis of standard bearings which require only a simple modification in a cage of a rolling bearing. The modification relates to the driving bush for the rolling elements. The rotational speed of the shaft is transmitted to the rolling elements of a bearing by way of the driving bush.

Furthermore, said friction-wheel planetary gear is integrated into the hub of the fan and therefore requires no additional axial installation space.

Thanks to the use of standard parts proven in countless applications, such as e.g. standard bearings, a failsafe implementation of said integrated fan is ensured. The principle of the friction-wheel planetary gear for integrated use in the fan hub consists in the transmission being dependent on the difference between the diameters of the orbital paths of the two rolling bearings. The smaller the difference, the greater is the transmission ratio of said gear.

The friction-wheel planetary gear which is advantageously constructed from rolling bearings comprises the following elements, inter alia:
two rolling bearings of different diameter,
a drive shaft on which the inner bearing rings of the two rolling bearings are pressed axially against each other,
a driving bush which transmits the rotational speed of the shaft onto the rolling elements of a rolling bearing, and
an intermediate ring which separates the outer rings of the two rolling bearings and thereby enables the inner rings to press against the outer rings.

Advantageously, the intermediate ring which separates the outer rings of the two rolling bearings simultaneously forms the fan hub from which the fan vanes extend substantially radially.

A virtual doubling of the rotational speed of the fan compared to the rotational speed of the shaft results in an eightfold increase in the output capacity of the fan.

This is of great advantage, in particular in the case of low-speed rotors, i.e. multipole dynamoelectric machines, since even at lower rotational speeds of the shaft an adequate air throughput for cooling is provided, without additional external forced ventilation.

The invention and further advantageous embodiments of the invention are explained in more detail with reference to a schematically illustrated exemplary embodiment. In the drawing the figure shows a longitudinal section through an inventive integrated fan of a dynamoelectric machine.

The figure also shows a fan vane 1 of an axial or radial fan which is positioned on a shaft 2 of a dynamoelectric machine which is depicted in more detail. The shaft 2 is co-rotationally connected to a short-circuit rotor 13 of the dynamoelectric machine, a short-circuit ring 14 being shown at the front face of the short-circuit rotor.

The shaft 2 can also be co-rotationally connected to another rotor, for example a rotor having an electrical excitation means or excitation by means of permanent magnets.

When the shaft 2 rotates, the rotational speed of said shaft 2 is transmitted with the aid of the driving bush 7 onto the balls 10 of a modified bearing 6. Said balls execute a rolling motion on a stationary inner ring 11 of the modified bearing 6. The inner ring 11 is fixed in position with the aid of a bearing cover 8. Owing to the kinematic transmission ratio the rotational speed of the outer ring 9 of the modified bearing 6 is now almost doubled in this case compared to that of the shaft 2. Because the outer ring 9 of the modified bearing 6 is press-fitted into a hub of the fan, the fan hub also rotates at the increased speed as a result.

In order to obtain an adequate torque transmission in the friction-wheel planetary gear, a pressure sleeve 3 on which a force is exerted by compression springs 4 is arranged in an axially displaceable manner on the shaft 2. Said pressure sleeve 3 is braced against the inner ring of the bearing 5. Irrespective of the rotational speed of the shaft, the bearing 5 conducts the axial compressive force by way of the outer ring of the bearing 5 to the fan hub 12.

In this arrangement the driving bush 7 is disposed between the two rolling bearings, i.e. the modified bearing 6 and the bearing 5.

The outer ring 9 is pressed against the balls 10 of the modified bearing 6 by way of a bearing collar in the fan hub 12. The thereby resulting contact friction limits the torque to be transmitted, thus creating an overload clutch.

What is claimed is:

1-5. (canceled)

6. A dynamoelectric machine, in particular a multipole dynamoelectric machine, comprising:
a shaft;
an integrated fan having a hub;
a friction-wheel planetary gear connecting the fan to the shaft, said friction-wheel planetary gear having first and second rolling bearings, said first rolling bearing having an outer ring mounted in the hub of the fan, and said second rolling bearing having an outer ring which is press-fitted in the hub of the fan; and
a driving bush arranged between the first and second rolling bearings for transmitting a rotational speed of the shaft onto balls of the second bearing to thereby increase a rotational speed of the fan by a predefined factor compared to the rotational speed of the shaft.

7. The dynamoelectric machine of claim 6, wherein the first and second rolling bearings have different diameters.

8. The dynamoelectric machine of claim 6, wherein the friction-wheel planetary gear is arranged in the hub of the fan.
